(19) United States
(12) Patent Application Publication
(10) Pub. No.: US 2005/0221208 A1
(43) Pub. Date: Oct. 6, 2005

(54) Resist pattern formation method, patterned substrate manufacturing method, and resist pattern formation apparatus

(75) Inventor: Katsuaki Murakami, Kumamoto (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Mitsubishi Denki Kabushiki Kaisha, Tokyo (JP)

(21) Appl. No.: 11/099,500

(22) Filed: Apr. 6, 2005

(30) Foreign Application Priority Data
Apr. 6, 2004 (JP) 2004-111852

(51) Int. Cl. G03B 27/00; G03C 5/00; G06K 9/00

(52) U.S. Cl. 430/30; 382/145; 355/18; 430/945

(57) ABSTRACT

A resist pattern formation apparatus includes a resist layer formation section of forming a resist layer on a substrate, an exposure section of applying light to the resist layer through a mask pattern, a development section of developing the resist layer, a defect inspection section of inspecting defect in a pattern of the resist layer, and a repair section of repairing a defect part of the pattern of the resist layer if needed according to an inspection result.

### BACKGROUND OF THE INVENTION

1. Field of the Invention

The present invention relates to a method for forming a resist pattern on a substrate, a resist pattern formation apparatus for implementing this method, and a method for manufacturing a patterned substrate.

2. Description of the Related Art

A conventional method for manufacturing semiconductor devices and liquid-crystal elements is as follows, for example. As shown in FIG. 1, after depositing a layer to be processed, which is referred to hereinafter as “work layer” (Sa1), a substrate is cleaned (Sa2) and dehydration baked (Sa3). The substrate is then coated with a resist solution (Sa4), and prebaked (Sa5). After that, the resist is exposed to light through a photomask (Sa6); further, the edge of the substrate is exposed to light (Sa7). Development (Sa8) and postbake (Sa9) are performed after that, thereby creating a desired resist pattern. Then, the work layer is etched (Sa10) and the unnecessary resist is removed (Sa11), thus creating a desired pattern in the work layer. If it is necessary to laminate another work layer on the patterned work layer, the above cycle is repeated. A semiconductor device or the like is manufactured in this way.

With increasing demand for a smaller device and feature size, line and electrode patterns formed in a work layer are more densely arranged. This makes the problem of pattern defects in the patterned work layers, such as line and electrode patterns, more serious. For example, if short-circuit occurs in the line patterns, incorrect voltage applied to a pixel electrode causes display defects or the like.

A conventional approach to repair a line or electrode pattern which is a work layer is to apply laser light to a pattern defect, which is a residual part to be removed, so as to burn off the short-circuited part with the irradiation energy of the laser light.

However, it is difficult in practice to control the irradiation output intensity, the output time and so on, of laser light for each defect part according to the area of an opening defect part or the film thickness of a residual pattern of the work layer to be removed. Thus, the shape of the work layer processed by the laser energy may be damaged in a cutting part of the work layer which is cut by the laser light. This affects adversely a thin film to be deposited later. For example, as shown in FIG. 2A, if laser light is applied to a pattern defect of a residual part of the work layer 71 to be removed, the work layer 71 (e.g. a thin metal film) may be curled up in the cutting part where the laser light is applied as shown in FIG. 2B. This may cause formation defects in a film 72 deposited next due to the step in the curled-up part. The formation defects include insulation failure if the film 72 is an insulation layer. Further, this technique has a risk of burning off the part of the work layer which is supposed to be left as an electrode pattern or a line pattern. This technique also has a risk of burning off the layer deposited below the work layer to be repaired by the laser light.

Formation defects in a work layer is caused mainly by a resist pattern formation failure. Thus, Japanese Unexamined Patent Application Publication No. 2003-287904 (Matsushima) describes a technique of applying laser light to a defect part of a resist pattern to prevent formation defects in a work layer, instead of repairing the defect part by directly applying laser light to the work layer. FIG. 3 is a flowchart in the case of applying this technique to the manufacturing process of FIG. 1. As shown in FIG. 3, after depositing a work layer (Sb1), a substrate is cleaned (Sb2) and dehydration baked (Sb3). The substrate is then coated with first resist (Sb4), and prebaked (Sb5) Further, the substrate is coated with second resist (Sb6) and prebaked (Sb7). After that, two resist layers are exposed together through a photomask (Sb8); further, the edge of the substrate is exposed (Sb9). Then, only the second resist layer is developed (Sb10) and postbaked (Sb11), thereby forming a desired resist pattern. At this time, the second resist pattern is inspected to check if it is patterned into a desired shape (Sb12). Presence or absence of a defect in the second resist pattern is determined, checking the presence of a part where the resist to be left as a part of the resist pattern is removed (Sb13) If a defect is found, laser light is applied to the first resist layer in the position corresponding to the defect part so that it forms a part of the pattern (Sb14). After that, the first resist layer is developed (Sb15) and postbaked (Sb16), thereby forming a desired resist pattern. Finally, the work layer is etched (Sb17) and unnecessary resist is removed (Sb18). Thus, even if the part to be left as a part of the resist pattern is removed for any reason, this technique applies the laser light to the first resist to form a part of the resist pattern, thereby preventing prevent pattern formation defects in the work layer.

Further, Japanese Unexamined Patent Application Publication No. 2004-54069 (Watamura) describes a technique to repair disconnection of a line pattern or the like.

The technique taught by Matsushima requires two-times of resist coating and development processes every time patterning a work layer as shown in FIG. 3. This causes an increase in the complexity of the manufacturing process, manufacturing equipment size, and manufacturing costs. Further, since one-time work layer processing includes two cycles of resist coating and development processes, it is unfavorable for the environment.

Though the case of coating resist over a work layer and etching the work film is described above, the same problem occurs in the lift-off process that first coats resist over a substrate and then forms and processes a work layer after that.

### SUMMARY OF THE INVENTION

In view of the foregoing, it is an object of the present invention to provide a method for forming a resist pattern which allows highly accurate pattern formation with a simple manufacturing method, a method for manufacturing a patterned substrate, and a resist pattern formation apparatus to implement the resist pattern formation method.

To these ends, according to one aspect of the present invention, there is provided a method for forming a resist pattern which includes forming a resist layer on a substrate, exposing the resist layer through a mask pattern, developing the exposed resist layer, inspecting defect in a pattern of the developed resist layer, and removing and repairing a defect part of the pattern of the resist layer according to an inspection result. Since this method removes and repairs a defect part of a resist pattern by a simple process, it is possible to repair a resist pattern formation defect part where a work layer which is supposed to be removed is still left. This allows forming a highly-accurate resist pattern.

Preferably, in the above method, a work layer to be processed with the pattern of the resist layer is formed on the substrate. Since this method allows forming a highly-accurate resist pattern by a simple process, it is possible to form a pattern of a work layer by etching with high accuracy.

In the above method, the defect part of the pattern of the resist layer may be removed and repaired with laser light. According to this method, even if the resist which is supposed to be removed is not removed, it is possible to repair a defect part by a simple process of applying laser light to the defect part.

According to another aspect of the present invention, there is provided a method for manufacturing a patterned substrate where a desired pattern is formed, which includes forming a work layer to be processed on a substrate, forming a resist layer on the work layer, exposing the resist layer through a mask pattern, developing the exposed resist layer, inspecting defect in a pattern of the developed resist layer, removing and repairing a defect part of the pattern of the resist layer according to an inspection result, and patterning the work layer using the pattern of the resist layer as a mask. Since this method allows forming a highly accurate resist pattern by a simple process, it is possible to form a highly accurate pattern of a work layer by etching.

According to another aspect of the present invention, there is provided an apparatus of forming a resist pattern, which includes a resist layer formation section of forming a resist layer on a substrate, an exposure section of applying light to the resist layer through a mask pattern, a development section of developing the exposed resist layer, a defect inspection section of inspecting defect in a pattern of the resist layer, and a repair section of repairing a defect part of the pattern of the resist layer according to an inspection result. Since this apparatus has a unit to repair defects in the resist pattern to be removed, it is possible to repair the resist pattern by a simple process even if the resist pattern which is supposed to be removed is not removed. This provides the resist pattern formation apparatus capable of forming a highly accurate resist pattern.

Preferably in the above apparatus, a work layer to be processed with the pattern of the resist layer is formed on the substrate. Since this method allows forming a highly-accurate resist pattern by a simple process, it is possible to form a pattern of a work layer by etching with high accuracy.

In the above apparatus, the repair section may include laser light to remove the defect part of the pattern of the resist layer by applying the laser light. According to this apparatus, even if the resist which is supposed to be removed is not removed, it is possible to repair a defect part by a simple process of applying laser light to the defect part.

The present invention can provide a method of forming a highly accurate resist pattern by a simple process and a resist pattern formation apparatus for implementing this method. Further, the present invention can provide a method of manufacturing a patterned substrate using a process of forming a highly accurate resist pattern easily.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a flowchart showing a resist pattern formation process according to a related art.

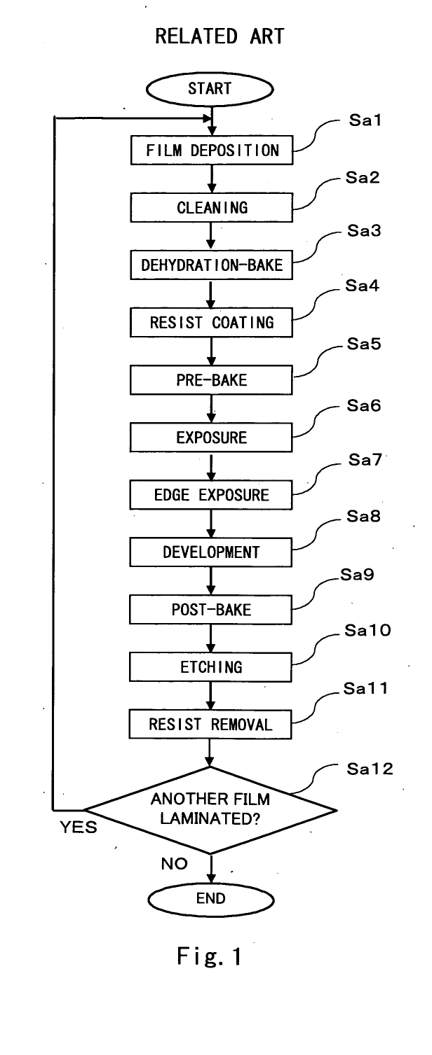

FIGS. 2A to 2C are views to explain the state where a work layer curls up due to defect repair according to a related art.

FIG. 3 is a flowchart showing a resist pattern formation process according to a related art.

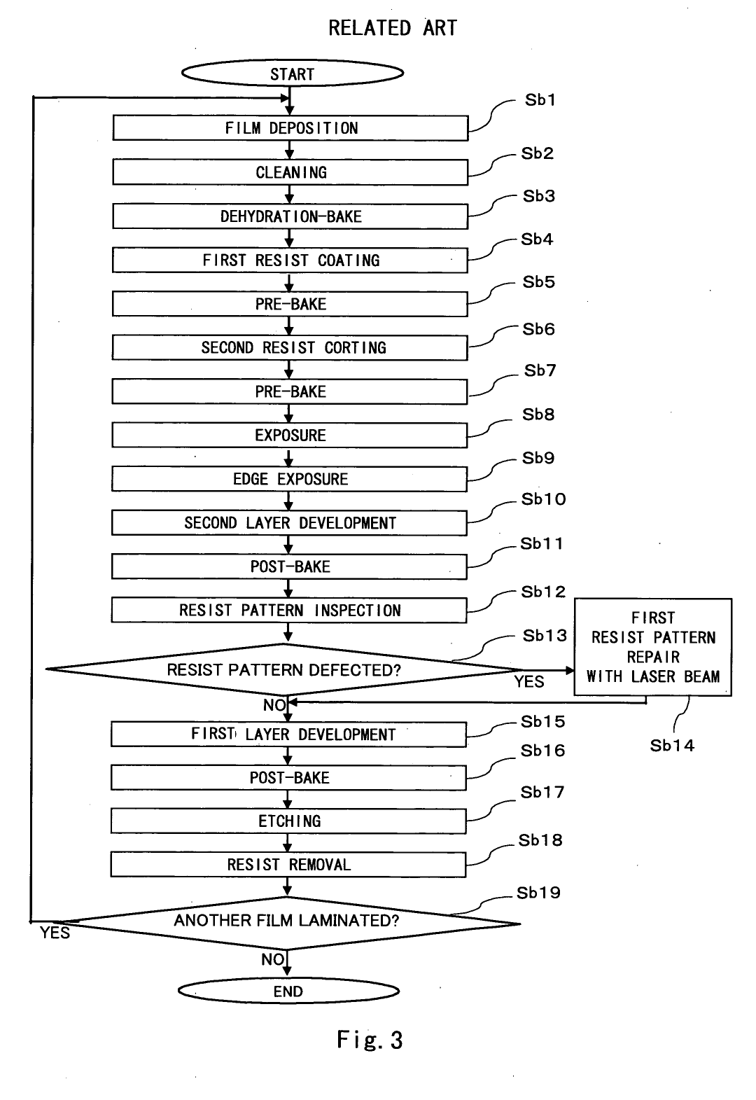

FIGS. 4A to 4G are views showing the process flow of a liquid crystal display device according to an embodiment of the invention.

FIG. 5 is a schematic view to explain a resist pattern formation apparatus according to an embodiment of the invention.

FIG. 6 is a flowchart showing a resist pattern formation process according to an embodiment of the invention.

### PREFERRED EMBODIMENT OF THE INVENTION

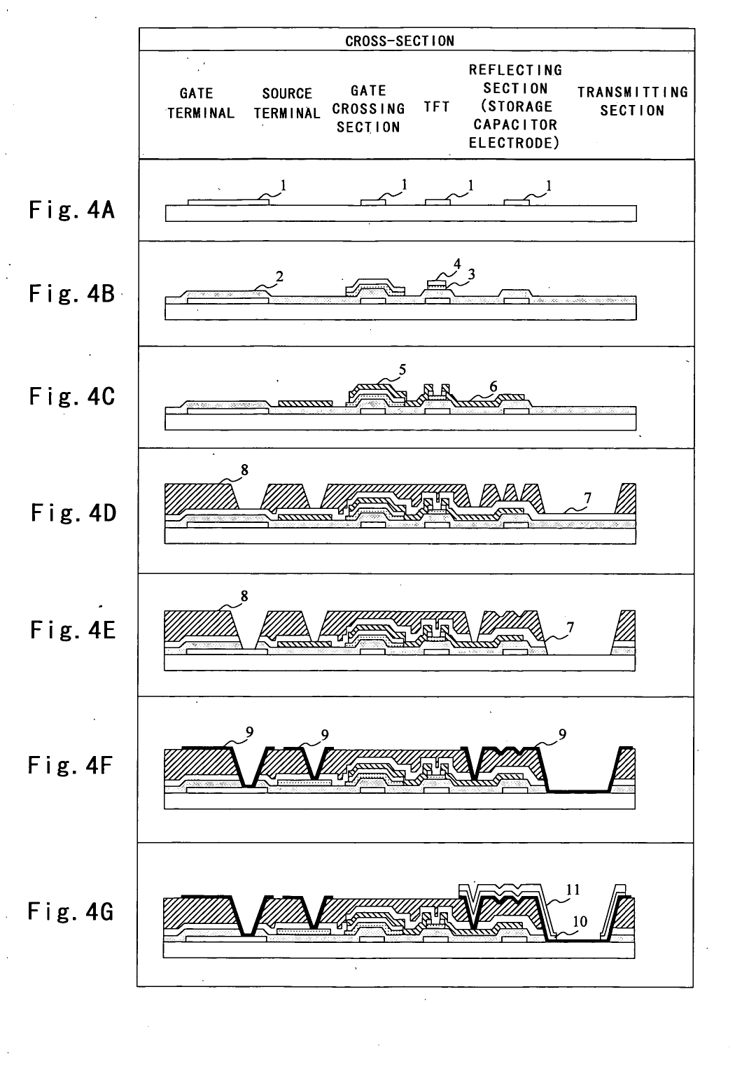

An embodiment of the present invention is described hereinafter. This embodiment applies the invention to a resist pattern formation device for manufacturing a substrate for a liquid crystal apparatus. Referring first to FIGS. 4A to 4G, the manufacturing process flow of a liquid crystal display apparatus of this embodiment is described. This process manufactures a semitransparent thin-film-transistor (TFT) array by seven times of photolithography processes. The TFT array includes a first thin metal film 1, a first insulation layer 2, a semiconductor active layer 3, an ohmic contact layer 4, a source electrode 5, a drain electrode 6, a second insulation layer 7, an organic layer 8, a transparent conductive thin film 9, and third thin metal films 10 and 11. The cross-sections of FIGS. 4A to 4G illustrate a gate terminal portion, a source terminal portion, a crossing portion of source and gate lines, TFT, a reflecting portion of a display area, and a transmitting portion of the display area, from left to right. A drive IC is connected to each of the source terminal portion and the gate terminal portion. The reflecting portion has a reflecting electrode of each pixel, and the transmitting portion has a transparent electrode of each pixel. The reflecting electrode and the transparent electrode constitute a pixel electrode of each pixel.

First, a glass substrate is washed to clean the surface. A transparent insulating substrate such as a glass substrate is used as the insulating substrate. Though the insulating substrate may be any thickness, the substrate not over 1.1 mm thick is preferred to produce a thin liquid crystal display device. If the insulating substrate is too thin, however, it could be distorted by thermal history of film depositions and other processes, causing a decrease in patterning accuracy. Thus, it is necessary to determine the thickness of the insulating substrate in consideration of the process to be used. Further, if the insulating substrate is made of brittle fracturable material such as glass, it is preferred to cut off the edges of the substrate in order to prevent any foreign matter introduction due to chipping. It is also preferred to make a notch on the insulating substrate to identify its direction in order to facilitate the processing management.

Next, the first thin metal film 1 is deposited by sputtering or the like. The first thin metal film 1 may be chromium, molybdenum, tantalum, titanium, aluminum, copper, or alloy combining another substance with one of those elements, for example. The thickness of the first thin metal film 1 may be 100 nm to 500 nm. Chromium with the thickness of 200 nm is used in a preferred embodiment.

The first thin metal film 1 is preferably made of a material which is resistant to surface oxidation or which is conductive even when oxidized since a contact hole will be formed by dry etching and further a conductive thin film will be deposited thereon in the following process. For this reason, it is preferred that at least the surface of the first thin metal film 1 is made of chromium, titanium, tantalum, or molybdenum. The first thin metal film 1 may be a laminate of different kinds of thin metal films, or a thin metal film with different compositions along the film thickness. If the first thin metal film is made of a material including aluminum, at least the surface is preferably made of aluminum nitride having the resistivity of 10 to 1000 μΩ.

Then, a first photolithography process is performed to pattern the first thin metal film into a gate electrode, a gate line, a storage capacitor electrode, and a storage capacitor line. This forms the configuration shown in FIG. 4A. The photolithography process is as follows. After cleaned, the TFT array substrate is coated with photoresist and dried. The photoresist is then exposed to light through a mask pattern on which a prescribed pattern is formed and developed. The photoresist pattern transferred from the mask pattern is thereby photolithographically formed on the TFT array substrate. After heat-hardening the photoresist, the first thin metal film is etched and the photoresist is striped away. The photolithography process is described in further detail later. If the photoresist and the TFT array substrate have such a low wettability as to repel the photoresist, treatment such as ultraviolet (UV) cleaning before the photoresist coating or vapor-coating of hexamethyldisilazane (HMDS) for the better wettability is carried out.

Further, if adhesion failure occurs between the photoresist and the TFT array substrate to cause the photoresist to come off, appropriate treatment may be carried out as needed, such as increasing a heat-hardening temperature or a heat-hardening time. The etching of the first thin metal film may be wet etching using a known etchant such as a solution of a mixture of cerium ammonium nitrate and nitric acid if the first thin metal film is made of chromium. The first thin metal film 1 is preferably etched in such a way that a pattern edge has a tapered shape in order to prevent short-circuit at the pattern edge due to a height difference from another line. The pattern edge is therefore etched to have a trapezoid shape cross section. In addition to the gate electrode, gate line, storage capacitor electrode, and storage capacitor line, marks and lines necessary for the TFT array substrate fabrication are formed in this process.

Then, the first insulation layer 2, the semiconductor active layer 3, and the ohmic contact layer 4 are deposited in succession by plasma chemical vapor deposition (CVD). The first insulation layer 2 to serve as a gate insulation layer may be formed of SiNx film, SiOy film, SiOzNw film, or a lamination film of those (x, y, z, and w are all positive numbers). The first insulation layer 2 is approximately 300 nm to 600 nm thick. The first insulation layer 2 is preferably thicker than the first thin metal film 1 since too thin film causes short-circuit at a crossing point between the gate line and the source line. In terms of display properties, on the other hand, a thinner film is preferable because a thick film causes a decrease in the on-state current of the TFT to decrease display quality. In a preferred embodiment, the first insulation layer 2 is formed by depositing SiN film of 300 nm thick and further depositing SiN film of 100 nm thick.

The semiconductor active layer 3 is formed of an amorphous silicon (a-Si) film or a poly silicon (p-Si) film. The semiconductor active layer 3 is approximately 100 nm to 300 nm thick. Too thin film causes missing defect in the ohmic contact layer 4 during dry etching, which is detailed later; on the other hand, too thick film results in reduction of on-state current of the TFT. Thus, the film thickness is determined in terms of controllability of etching depth in dry-etching of the ohmic contact layer 4 and a necessary amount of on-state current of the TFT. If the semiconductor active layer 3 is formed by a-Si film, an interface of the first insulation layer 2 and the a-Si film is preferably SiNₓ film or SiO_{z}N_{w} film for better controllability of Vth of the TFT or a gate voltage to turn on the TFT and for higher reliability.

On the other hand, if the semiconductor active layer 3 is formed by p-Si film, an interface of the first insulation layer 2 and the p-Si film is preferably SiO_{y} film or SiO_{z}N_{w} film for better controllability of Vth of the TFT and for higher reliability. Further if the semiconductor active layer 3 is formed by the a-Si film, it is preferred to deposit a film with a smaller deposition rate in a lower part adjacent to the first insulation layer 2, and with a larger deposition rate in an upper layer in order to obtain the TFT property of larger mobility in a shorter deposition time and reduce leakage current during the off-state of the TFT. In a preferred embodiment, a-Si film of 150 nm thick is deposited as the semiconductor active layer 3.

The ohmic contact layer 4 is formed by n-p-Si film or n-a-Si film that is a-Si doped with phosphorus (P). The ohmic contact layer 4 may be approximately 20 nm to 70 nm thick. The SiNx film, SiOy film, SiOzNw film, a-Si film, p-Si film, n-a-Si film, and n-p-Si film can be deposited by using known gas such as SiH4, NH3, H2, NO2, PH3, N2, and mixed gas of those. In a preferred embodiment, n-a-Si film of 30 nm thick is deposited as the ohmic contact layer 4.

Then, the second photolithography process is performed to pattern the semiconductor active layer 3 and the ohmic contact layer 4 at least in the portion where the TFT is to be formed. This forms the configuration shown in FIG. 4B. The first insulation layer 2 remains all over the substrate. It is preferred that the semiconductor active layer 3 and the ohmic contact layer 4 are left by patterning at crossing points of the source lines with the gate lines and the storage capacitor lines in addition to the portion where the TFT is to be formed in order to increase a resistance voltage at the crossing point. Further, the semiconductor active layer 3 and the ohmic contact layer 4 in the TFT portion preferably extend to a lower part of the source line. This prevents the source electrode from crossing the step edge between the semiconductor active layer 3 and the ohmic contact layer 4 where there is a difference in level, thus avoiding disconnection of the source electrode.

The semiconductor active layer 3 and the ohmic contact layer 4 may be dry-etched using known gas composition such as mixed gas of SF6 and O2 or of CF4 and O2.

Then, the second thin metal film is formed by sputtering or the like. The second thin metal film may be made of chromium, molybdenum, tantalum, titanium, aluminum, copper, alloy combining another substance with one of those elements, or lamination film of those, for example. Chromium of 200 nm thick, for example, is deposited in a preferred embodiment.

Then, the third photolithography process is performed to pattern the second thin metal film into the source electrode 5 and the drain electrode 6. This forms a configuration shown in FIG. 4C. The source electrode 5 extends to the crossing point between the source line and the gate line. The drain electrode 6 extends to a reflecting portion. Next, the ohmic contact layer 4 is etched to remove the central part of the ohmic contact layer 4 in the TFT portion, thereby exposing the semiconductor active layer 3. The ohmic contact layer 4 may be dry-etched using known gas composition such as mixed gas of SF6 and O2 or of CF4 and O2.

The second insulation layer 7 is formed by plasma CVD. An organic layer 8 is then formed by spin coating, slit coating, transcription, and so on. SiN of 100 nm thick is used as the second insulation layer 7 in a preferred embodiment. The organic layer 8 is a known photosensitive organic layer such as PC 335 or PC 405 made by JSR Corporation.

Then, the fourth photolithography process is performed to pattern the organic layer 8 into the form shown in FIG. 4D. Specifically, the organic layer 8 is patterned so as to expose the portion where the first insulation layer 2 and the second insulation layer 7 are to be removed by the following fifth photolithography process. Further, the organic layer 8 is partly removed in the reflecting section to have an irregular shape. This configuration scatters outside light to provide good display characteristics.

The fifth photolithography process is performed to pattern the first insulation layer 2 and the second insulation layer 7 into the form shown in FIG. 4E. The etching makes a tapered shape.

For the gate terminal portion, the first insulation layer 2 and the second insulation layer 7 are both removed to expose the first thin metal film 1, for forming a contact hole electrically connecting the gate line with a driving signal source. For the source terminal portion, the second insulation layer 7 is removed to expose the second thin metal film. In the area between the TFT portion and the reflecting portion, the second insulation layer is removed to expose the drain electrode 6. Further, in the transmitting portion, the first insulation layer 2 and the second insulation layer 7 are both removed to expose the first insulating substrate. If the organic layer 8 in the transmitting portion is not removed, it is preferred to add a known bleaching process or a process to enhance transparency of the photosensitive organic layer by ultraviolet light exposure after the patterning of the organic layer by the photolithography process.

Then, the conductive thin film 9 is deposited by sputtering or the like. The conductive thin film 9 may be formed by a transparent conductive film such as ITO and SnO2. ITO is preferred to obtain better chemical stability. ITO of 80 nm thick is used as the conductive thin film 9 in a preferred embodiment. Though the ITO may be either crystallized ITO or amorphous ITO, it is necessary for the amorphous ITO to be heated to 180° C. and above for crystallization before depositing the third thin metal film. The amorphous ITO is heated to 200° C. or above in a preferred embodiment.

Then, the sixth photolithography process is performed to pattern the conductive thin film 9 into a pixel electrode or the like as shown in FIG. 4F. Depending on the material used, the conductive thin film 9 may be wet etched using known etchant such as a solution of a mixture of hydrochloric acid and nitric acid if the conductive thin film 9 is made of crystallized ITO, for example. If the conductive thin film 9 is made of ITO, dry-etching using known gas composition such as HI and HBr is also possible. Besides the pixel electrode, this process further forms an electrode of the conductive thin film 9 in a transfer terminal portion for electrically connecting a counter substrate and the TFT array substrate with resin including conductive particles. The patterning of the amorphous ITO may be carried out in the same way as the crystallized ITO if after the heating is carried out or by using a solution of a mixture of known oxalic acid if before the heating.

After that, the third thin metal films 10 and 11 are deposited by sputtering or the like. As the third thin metal films 10 and 11, a thin film of 100 nm to 500 nm thick composed of chromium, molybdenum, tantalum, titanium, aluminum, copper, or alloy combining another substance with one of those elements, for example, may be used. The thin metal film 10 prevents the thin metal film 11 from being broken at a step edge of a contact hole or the like. If the breakage is negligible, it is possible not to form the thin metal film 10, which eliminates dispense with one process step and reduces costs. In a preferred embodiment, after chromium of 100 nm thick is deposited, an alloy of aluminum and Cu of 300 nm thick is deposited, and chromium of 100 nm thick is further deposited thereon. Chromium is provided at a top layer directly under an alignment layer since if the alloy of aluminum and Cu is exposed it causes a corrosion of the ITO 9 at the time of development in the following photolithography process. Use of molybdenum, tantalum, or tungsten, instead of Chromium, results in the same effect.

Then, the seventh photolithography process is performed to pattern the third thin metal films 10 and 11 and the chromium of the top layer into a shape of a reflective electrode, and then the chromium of the top layer is etched away, thereby forming the reflective electrode. If the organic layer in the transmitting portion is removed, alignment defect of liquid crystals can occur due to a step edge of the organic layer, which decreases display quality. To avoid this, the inner side portion of the step is preferably covered with the reflective electrode as shown in FIG. 4G. Our various studies show that the alignment defect can occur in a range between 2 μm and 6 μm away from the step portion. The reflective electrode needs to have an overlap of 2 μm at least, and 6 μm is enough even in a case where smaller aperture ratio of transmission is allowable. Thus, 2 μm to 6 μm is a preferable overlap length.

If the thin metal film 10 is made of chromium, it can be etched at the same time as the chromium of the top layer. Also, if the thin metal film 10 and a thin metal film of the top layer are made of the same material, they can be removed in one etching process. The reflective electrode is formed as a lamination layer of the thin metal film 10 of chromium and the thin metal film 11 of an alloy of aluminum and Cu on the thin metal film 10. The chromium of the top layer is formed for preventing corrosion of the ITO 9, and it is removed in this step for higher reflectance. The third thin metal film may be wet-etched using known etchant. The above process eventually forms a configuration shown in FIG. 4G. As described above, the feature of liquid crystal display device of this embodiment is to place the reflective electrodes 10, 11, and the conductive thin film 9 without interposing an insulation layer therebetween.

As explained in the foregoing, the TFT array substrate is fabricated by seven times of the photolithography processes, thereby attaining high manufacturing yields. Though the above embodiment describes the case of forming two layers of the third thin metal films 10 and 11, it is possible to form a single layer of the third thin metal film 11.

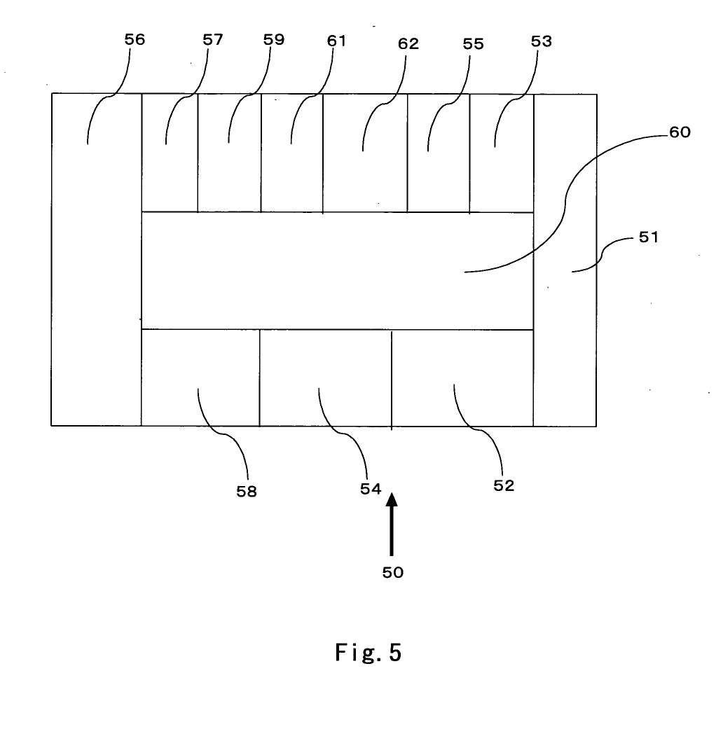

A photolithography process or a resist pattern formation process of this embodiment is described hereinafter. FIG. 5 is a schematic diagram illustrating an example of a resist pattern formation apparatus 50 of this embodiment. The resist pattern formation apparatus 50 includes a substrate carry in/out unit 51 for carrying a substrate in or out of the apparatus, a cleaning unit 52, a dehydration bake unit 53, a resist coating unit 54, a prebake unit 55, an exposure unit 56, an edge exposure unit 57, a development unit 58, and a postbake unit 59. The resist pattern formation apparatus 50 also includes carrying means 60 for carrying a substrate between the units. It further includes a resist pattern inspection unit 61 and a resist pattern repair unit 62.

The structure of each unit is explained below. The carrying means 60 is movable left to right, back and forth, and up and down so as to take out the substrate which has been processed in each unit and transfers it to the next processing unit. A substrate holding portion in each unit can hold the substrate horizontally by vacuum contact. The cleaning unit 52 has a cleaning solution supply nozzle above a liquid receiving cup. The nozzle is connected to a cleaning solution tank by a supply pipe via a valve. The dehydration bake unit 53 has a heating plate to heat the substrate. The resist coating unit 54 has a supply nozzle having a plurality of supply ports above a liquid receiving cup. The nozzle is connected to a resist supply tank by a resist supply pipe via a valve.

The prebake unit 55 has a heating plate to volatilize the solvent of a resist solution. The exposure unit 56 applies prescribed light to a substrate coated with the resist solution from an exposure portion through a prescribed pattern mask. The exposure unit 56 includes a light source, a lens and so on. The exposure unit 56 can set a desired exposure time, exposure focal spot, and position. The edge exposure unit 57 has a light source, a lens and so on to expose the edge of the substrate. The development unit 58 has a development solution supply nozzle above a development solution receiving cup. The nozzle is connected to a development solution tank by a supply pipe via a valve. The postbake unit 59 has a heating plate to heat the substrate after development.

The resist pattern inspection unit 61 has a CCD camera movable in the X, Y, and Z directions for inspecting a resist pattern. The image of the substrate taken by the CCD camera is analyzed by a data processing section such as a personal computer connected thereto. The resist pattern repair unit 62 has a substrate mounting block movable in the X, Y, and Z directions and a laser. The resist pattern repair unit 62 receives inspection results of the resist pattern inspection unit from the personal computer or the like.

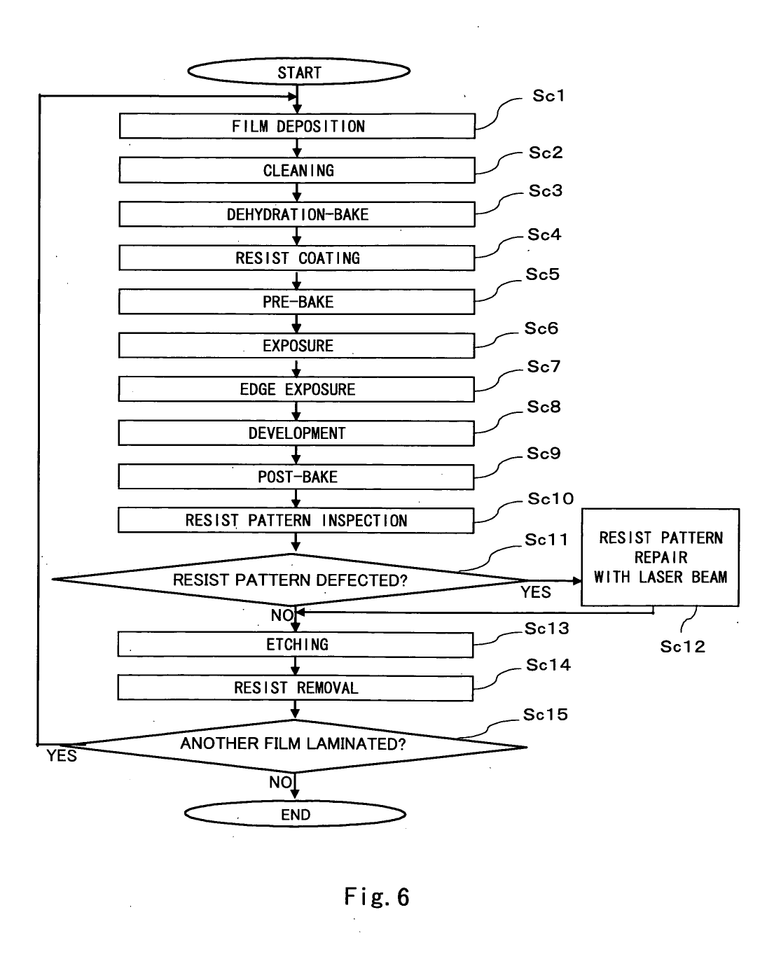

The operation of the resist pattern formation apparatus is described hereinafter. FIG. 6 is a flowchart showing a photolithography process for forming a resist pattern according to this embodiment. Though this embodiment performs seven times of photolithography processes as described above, the third photolithography process is described below as an example.

First, a carrier containing a substrate S, see FIG. 4, where the second thin metal film is deposited (Sc1) is carried into the mounting block of the substrate carry in/out unit 51 and delivered to the carrying means 60 by a carrying arm.

The carrying means 60 carries the substrate S to the cleaning unit 52. The cleaning unit 52 cleans the substrate S by supplying a cleaning solution which is adjusted to a prescribed temperature to the central part of the substrate S and rotating the substrate S with a prescribed number of rotations and acceleration (Sc2). After cleaning the substrate S, the dehydration unit 53 dries the substrate S by heating for a prescribed time period at a prescribed temperature (Sc3). This step completely removes the cleaning solution from the substrate.

After that, the substrate S is carried to the resist coating unit 54. The resist coating unit 54 drops a resist solution onto the substantially central part of the substrate S and rotates the substrate S with a prescribed number of rotations. The resist solution spreads in the substrate radial direction by the centrifugal force to form a liquid film of the resist solution over the substrate surface. The solution which is thrown off flows into the liquid receiving cup (Sc4). The resist is coated over the substrate in this way. After the resist coating, the prebake unit 55 dries the substrate S by heating for a prescribed time period at a prescribed temperature to volatilize the solvent of the resist solution (Sc5).

Then, the substrate S is carried to the exposure unit 56. The exposure unit 56 applies light to the resist coated surface through a mask (Sc6). Then, the edge exposure unit 57 exposes the edge of the exposed substrate S in order to remove the resist in the edge of the substrate S (Sc7). After the edge exposure, development is carried out (Sc8) and the postbake unit 58 dries the substrate S by heating (Sc9).

The developed substrate S is carried to the pattern inspection unit 61. The pattern inspection unit 61 inspects defects in the resist pattern (Sc10). The inspection determines presence or absence of defects (Sc11). If the inspection result shows no defect, the substrate S is carried to the substrate carry in/out unit 51 to proceed to the next step such as etching (Sc13). If, on the other hand, the inspection results in rejection showing failure to form a desired resist pattern, the substrate S is carried to the resist pattern repair unit 62. The resist pattern repair unit 62 applies laser light of 1064 nm, which is a fundamental wave, pin-pointedly on the defect part of the resist pattern (Sc12). The laser spot on the substrate, however, is preferably 2 μm or larger in diameter in terms of processing accuracy. The intensity of the laser light is preferably about 0.01 to 10 mJ/pulse. A radiation time period, the number of radiation pulses, and a radiation interval are preferably 5 to 25 ns/pulse, 1 to 5 cycle, and 3 to 4 cycle/s, respectively.

If the defect part of the resist pattern where the portion supposed to be removed is still left is etched in Sc13 by skipping the steps Sc10, Sc11, and Sc12, short-circuit occurs in the liquid-crystal display substrate. Since this embodiment includes the steps Sc10, Sc11, and Sc12, it can avoid short-circuit by a simple configuration.

The above conventional technique of repairing a work layer by laser light application requires the output intensity of about 5 to 50 mJ/pulse under the condition of the above radiation time period, number of radiation pulses, and radiation interval. This embodiment allows reducing the laser output intensity by about 80% compared to the case of repairing a worked layer by laser light.

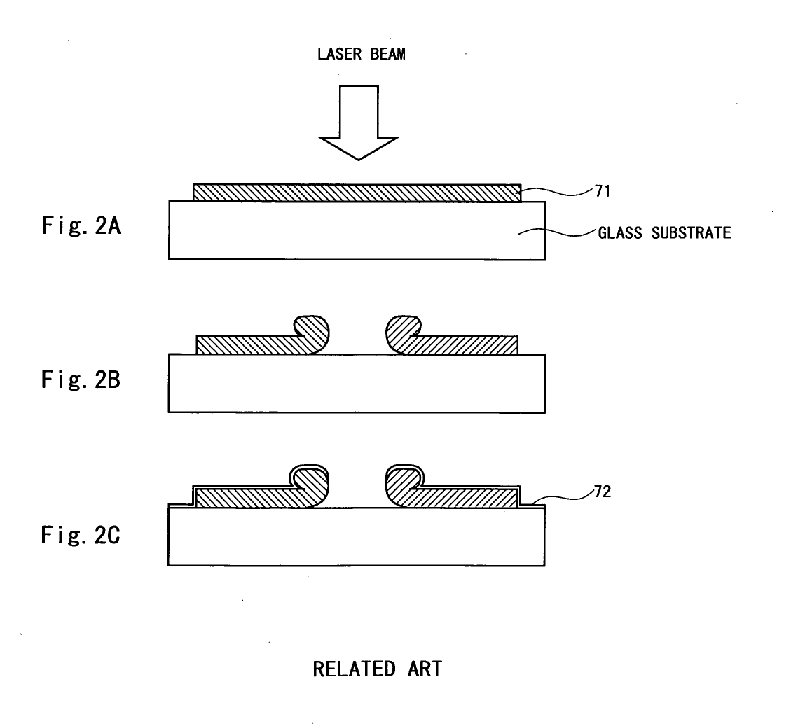

The above conventional technique also has the problem that the shape of a part of the work layer cut by the laser light affects adversely a thin film deposited later as described earlier with reference to FIG. 2. Further, since the irradiation output intensity is high, this technique has a risk of burning off the part of the work layer which is supposed to be left as patterns. This technique also has a risk of burning off not only the work layer to be repaired but also the layer deposited below the work layer with the laser light.

Since this embodiment reduces the laser output intensity by about 80% compared to the conventional technique, the shape of a work layer processed by the laser energy not damaged in the cutting part of the work layer which is cut by the laser light. Thus, no adverse effect is given to the thin film deposited later. Further, the 80% decrease in the laser output strength reduces the risk of burning off the work layer to be left as an electrode pattern or the like. The 80% decrease in the laser output intensity reduces the risk of burning off the lower layer. Even if the energy of the laser light reaches the level to burn off the work layer below the resist, it causes no defect since this is a part which is subject to be processed. This embodiment is particularly suitable for a display apparatus where a meal layer is deposited on an organic layer since this configuration is likely to be affected by the laser light.

The substrate S which is repaired by the laser light is carried again to the resist pattern inspection unit 61. The resist pattern inspection unit 61 inspects defects in the resist pattern (Sc10) and, if no defect is found, the substrate S is carried to the substrate carry in/out unit 51. Etching is then carried out (Sc13), and the resist is removed (Sc14). The pattern formation of the second metal thin film is thereby completed. If it is necessary to laminate another layer on top, the above process is repeated.

The liquid crystal substrate manufactured in the above process is adhered to a counter substrate having a color filter, and liquid crystals are placed therebetween. Further, a backlight unit is incorporated at the back. The liquid crystal display apparatus is thereby completed.

The laser light is not necessarily fundamental wave but may be the second higher harmonic wave of 532 nm or the third higher harmonic wave of 355 nm.

Though the above embodiment describes the case where a work layer is a metal film, this invention may be applied to the first insulation layer 2, the second insulation layer 7, and the organic layer 8. For example, it is effective to prevent disconnection in a contact hole.

In order to make assurance double sure, it is also possible to perform inspection of the pattern of the work layer and repair of a defect part after the etching using the resist pattern inspection unit 61 and the resist pattern repair unit 62 of the resist pattern formation apparatus. In this case, the output strength of the laser light is adjusted according to the material and the thickness of the work layer. This configuration allows use of the same apparatus for different purposes simply by adjusting the output strength of the laser light.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A method for forming a resist pattern, comprising:
forming a resist layer on a substrate;
exposing the resist layer through a mask pattern;
developing the exposed resist layer;
inspecting defect in a pattern of the developed resist layer; and
removing and repairing a defect part of the pattern of the resist layer according to an inspection result.

2. The method for forming a resist pattern according to claim 1, wherein a work layer to be processed with the pattern of the resist layer is formed on the substrate.

3. The method for forming a resist pattern according to claim 1, wherein the defect part of the pattern of the resist layer is removed and repaired with laser light.

4. The method for forming a resist pattern according to claim 2, wherein the defect part of the pattern of the resist layer is removed and repaired with laser light.

5. A method for manufacturing a patterned substrate where a desired pattern is formed, comprising:
forming a work layer to be processed on a substrate;
forming a resist layer on the work layer;
exposing the resist layer through a mask pattern;
developing the exposed resist layer;
inspecting defect in a pattern of the developed resist layer;
removing and repairing a defect part of the pattern of the resist layer according to an inspection result; and
patterning the work layer by using the pattern of the resist layer as a mask.

6. A method for manufacturing a patterned substrate according to claim 5, wherein the defect part of the pattern of the resist layer is removed and repaired with laser light.

7. An apparatus of forming a resist pattern, comprising:
a resist layer formation section of forming a resist layer on a substrate;
an exposure section of applying light to the resist layer through a mask pattern;
a development section of developing the exposed resist layer;
a defect inspection section of inspecting defect in a pattern of the resist layer; and
a repair section of repairing a defect part of the pattern of the resist layer according to an inspection result.

8. The apparatus of forming a resist pattern according to claim 7, wherein a work layer to be processed with the pattern of the resist layer is formed on the substrate.

9. The apparatus of forming a resist pattern according to claim 7, wherein the repair section comprises a laser to remove the defect part of the pattern of the resist layer by applying laser light.

10. The apparatus of forming a resist pattern according to claim 8, wherein the repair section comprises a laser to remove the defect part of the pattern of the resist layer by applying laser light.
